(19) United States
(12) Patent Application Publication
(10) Pub. No.: US 2024/0216116 A1
(43) Pub. Date: Jul. 4, 2024

(54) Gingival Pocket Measurement Device And Method Of Use

(71) Applicant: Jasmyn Hugan, Nashville, TN (US)

(72) Inventor: Jasmyn Hugan, Nashville, TN (US)

(21) Appl. No.: 18/090,637

(22) Filed: Dec. 29, 2022

(51) Int. Cl. A61C 19/04

(52) U.S. Cl. CPC A61C 19/043; A61C 2201/002

(57) ABSTRACT

A gingival pocket measurement device for facile and accurate measurement of a depth of a gingival pocket includes a rod, which in turn comprises first and second segments that extend from first and second ends of the rod, respectively. The second segment is tapered between the second end and a junction of the first and second segments so that the second end is circumferentially smaller than the junction. The bands of a plurality of bands are attached to the second segment at 1.0 mm increments from the second end. Each band extends circumferentially around the rod and has a respective color so that the plurality of bands comprises bands of variety of colors. The first end is selectively attachable to an elongate shaft, enabling a user to insert the rod into a gingival pocket to measure its depth by observing a respective band that is not covered by a gum.

### CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to periodontal probes and more particularly pertains to a new periodontal probe for facile and accurate measurement of a depth of a gingival pocket. The present invention discloses a periodontal probe having a plurality of colored bands allowing for measurement of a depth of a gingival pocket in millimeter increments.

### (2) Description of Related Art Including Information Disclosed Under 37 CFR 1.97 and 1.98

The prior art relates to periodontal probes. The most relevant prior art located is U.S. Pat. No. 5,423,677, which discloses a periodontal probe that is hollow and selectively attachable to a light emitting shaft. The periodontal probe has three colored bands corresponding to different stages of periodontal disease. The colored bands are 2-3 mm wide. The periodontal probe also comprises a plurality of numbered graduations within the colored bands, which may be spaced at 1 mm. Thus, to make an accurate measurement of a depth of a gingival pocket, a user must rely on the numbered graduations. Related prior art comprises periodontal scaling instruments wherein a debridement portion of the instrument comprises colored bands and internally illuminated dental probes with light emitting notches proximate to tips of the probes. The prior art does not teach a periodontal probe having a plurality of colored bands, wherein each colored band corresponds to a specific depth measurement in millimeter increments.

### BRIEF SUMMARY OF THE INVENTION

An embodiment of the disclosure meets the needs presented above by generally comprising a rod, which in turn comprises a first segment, which extends from a first end of the rod, and a second segment, which extends from a second end of the rod to the first segment. The first end is configured to be selectively attachable to an elongate shaft so that the rod is removably mountable to the elongate shaft. The second segment tapers from a junction of the first segment and the second segment to the second end so that the second end is circumferentially smaller than the junction. A plurality of bands is attached to the second segment, with each band extending circumferentially around the rod and having a respective color so that the plurality of bands comprises bands having a variety of colors. The bands are positioned at 1.0 mm increments from the second end. The rod is configured to be inserted into a gingival pocket, enabling a user to measure a depth of the gingival pocket by observing a respective band that is not covered by a gum.

Another embodiment of the disclosure include a method of measuring a depth of a gingival pocket. Provision steps entail providing an elongate shaft and a gingival pocket measurement device, according to the disclosure above. A preparatory step is attaching the rod to the elongate shaft. Operational steps of the method are grasping the elongate shaft in a hand, inserting the second segment of the rod into a gingival pocket, and observing a respective band not covered by a gum.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a gingival pocket measurement device according to an embodiment of the disclosure.

FIG. 2 is an isometric perspective view of an embodiment of the disclosure.

FIG. 3 is a detail view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

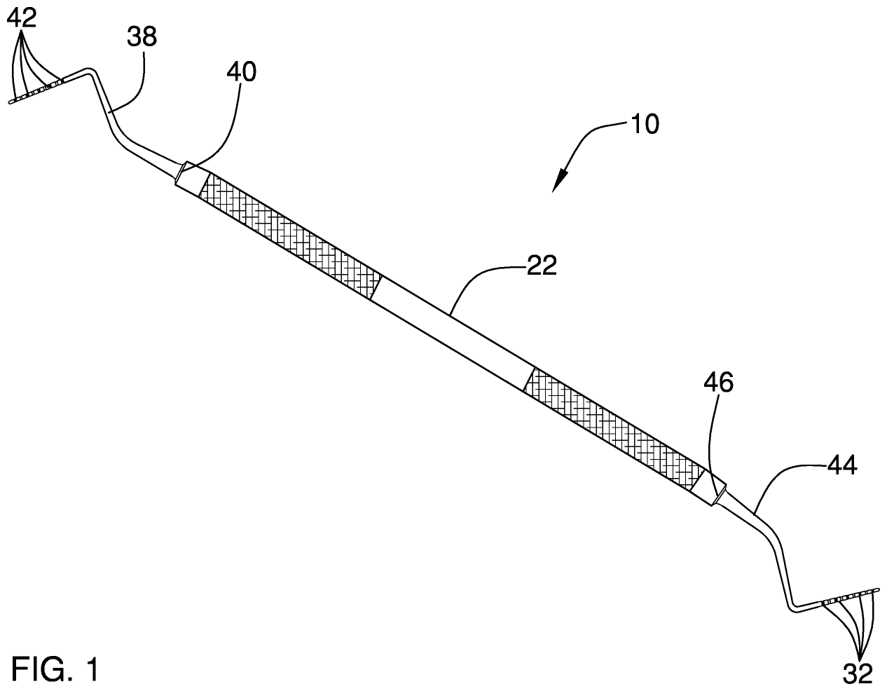

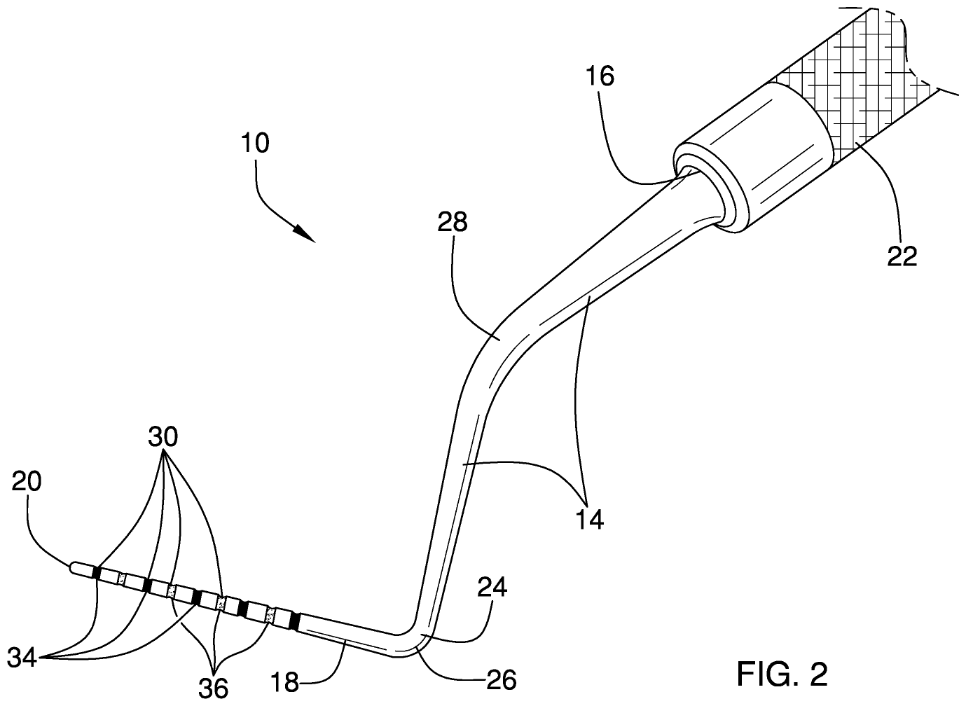

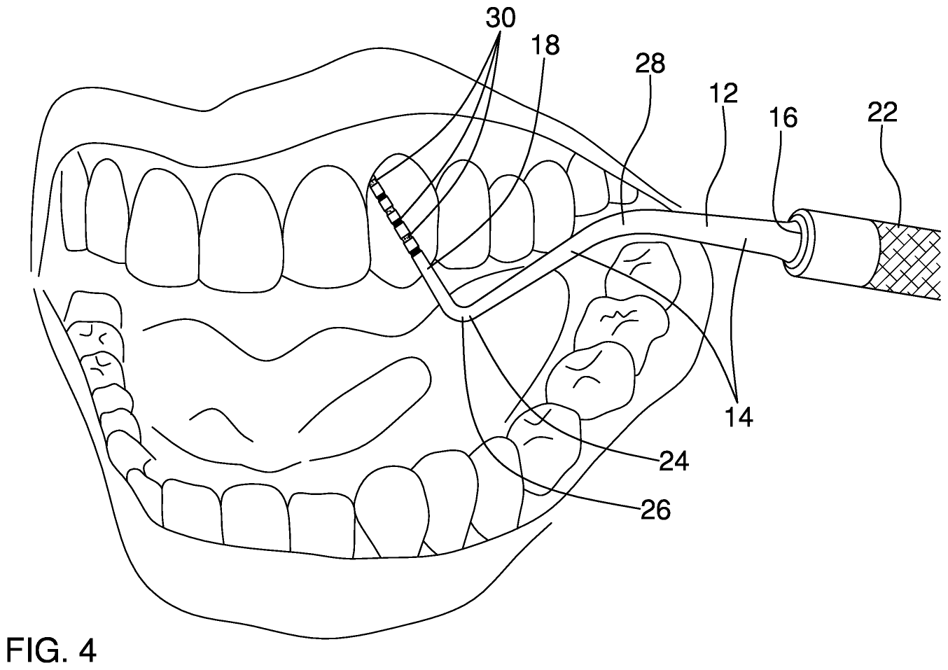

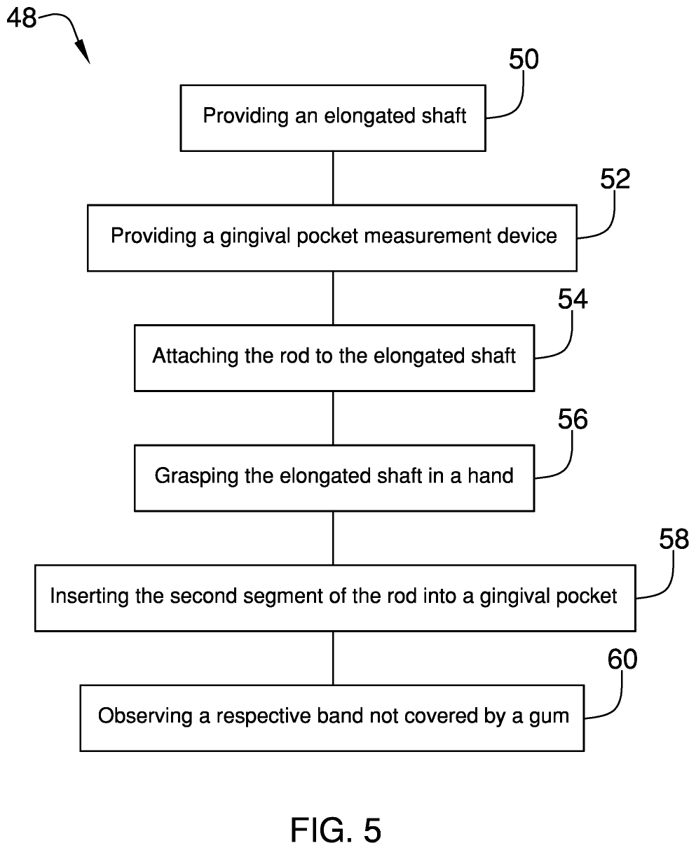

With reference now to the drawings, and in particular to FIGS. 1 through 5 thereof, a new periodontal probe embodying the principles and concepts of an embodiment of the disclosure and generally designated by the reference numeral 10 will be described.

As best illustrated in FIGS. 1 through 5, the gingival pocket measurement device generally comprises a rod 12, which in turn comprises a first segment 14, which extends from a first end 16 of the rod 12, and a second segment 18, which extends from a second end 20 of the rod 12 to the first segment 14. The first end 16 is configured to be selectively attachable to an elongate shaft 22 so that the rod 12 is removably mountable to the elongate shaft 22. The present invention also anticipates the rod 12 being integral to the elongate shaft 22.

The second segment 18 tapers from a junction 24 of the first segment 14 and the second segment 18 to the second end 20 so that the second end 20 is circumferentially smaller than the junction 24. A bend 26 is positioned in the rod 12 at the junction 24 and a curve 28 is positioned in the rod 12 substantially equally distant from the junction 24 and the first end. The bend 26 and the curve 28 improve the ergonomics of the gingival pocket measurement device 10.

A plurality of bands 30 is attached to the second segment 18, with each band 30 extending circumferentially around the rod 12 and having a respective color so that the plurality of bands 30 comprises bands 30 having a variety of colors. The bands 30 are positioned at 1.0 mm increments from the second end 20. The rod 12 is configured to be inserted into a gingival pocket, enabling a user to measure a depth of the gingival pocket by observing a respective band 30 that is not covered by a gum. Such measurements are commonly performed to assess the health of gums and to provide opportunities for early intervention in gum disease.

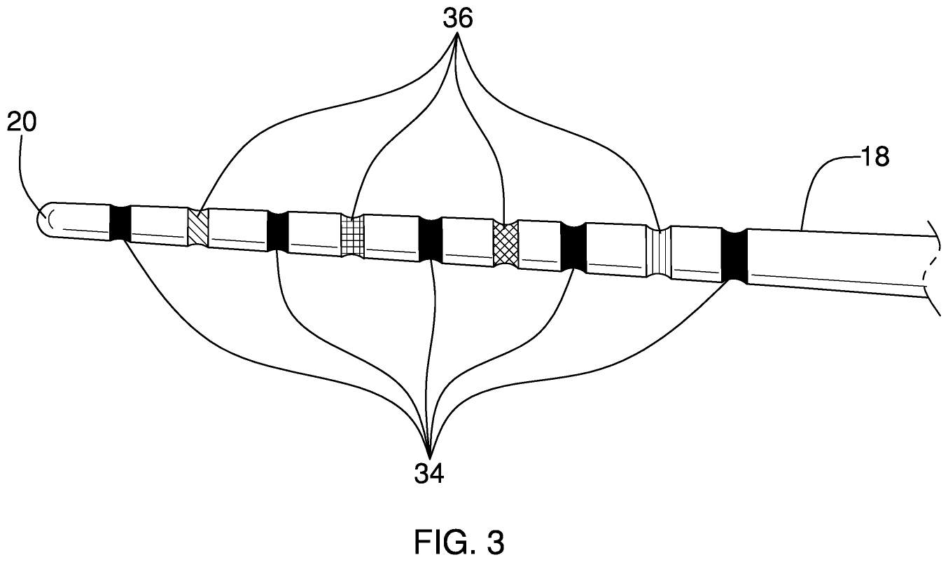

The plurality of bands 30 comprises from seven to eleven bands 30 and may comprise nine bands 30, as shown in FIG. 3. The plurality of bands 30 may comprise a set on first recesses 34 and a set of second recesses 36. The first recesses 34 are black and a respective one of the first recesses 34 is positioned at 1.0 mm from the second end 20 of the rod 12. The second recesses 36 are nonblack and each second recess 36 is bracketed by two first recesses 34. Rather than comprising first recesses 34 and second recesses 36, the plurality of bands 30 also could comprise a plurality of first protruding rings and a plurality of second protruding rings, a set of first flush inserts and a set of second flush inserts, or the like.

As shown in FIG. 3, the set of second recesses 36 may comprise four second recesses 36, which are colored green, yellow, orange, and red and which are positioned at 2.0 mm, 4.0 mm, 6.0 mm, and 8.0 mm from the second end 20, respectively. While other colors are anticipated for the second recesses 36 of the second set of recesses 36, the preceding color scheme is readily interpretable by those skilled in the art of gingival depth measurements. Additionally, while the present invention anticipates the bands 30 being positioned at increments other than 1.0 mm, the 1.0 mm increment is most commonly used in gingival depth assessment.

In one configuration, as shown in FIG. 1, the rod 12 comprises a first rod 38, which is configured to be selectively attachable to a first endpoint 40 of the elongate shaft 22. The plurality of bands 30 in this configuration comprises a plurality of first bands 42. A second rod 44, which is a mirror image of the first rod 38, is configured to be selectively attachable to a second endpoint 46 of the elongate shaft 22. The present invention anticipates the first rod 38 and the second rod 44 being integral to the elongate shaft 22.

In the configuration shown in FIG. 1, a plurality of second bands 32 is attached to the second segment 18 of the second rod 44. Each second band 32 extends circumferentially around the second rod 44 and has a respective color so that the plurality of second bands 32 comprises second bands 32 having a variety of colors. The second bands 32 are positioned at 1.0 mm increments from the second end 20 of the second rod 44. The second rod 44 is configured to be inserted into the gingival pocket, enabling the user to measure the depth of the gingival pocket by observing the respective second band 32 that is not covered by the gum. A gingival pocket measurement device 10 having both the first rod 38 and the second rod 44 has improved ergonomics, as the right and left sides a set of teeth are substantially mirror images of one another.

In use, the gingival pocket measurement device 10 enables a method of measuring a depth of a gingival pocket 48. The method 48 comprises a first provision step 50 and a second provision step 52, which entail providing an elongate shaft 22 and providing a gingival pocket measurement device 10, according to the specification above, respectively. A preparatory step 54 of the method 48 is attaching the rod 12 to the elongate shaft 22. A first operational step 56 of the method 48 is grasping the elongate shaft 22 in a hand. A second operational step 58 of the method 48 is inserting the second segment 18 of the rod 12 into a gingival pocket. A third operational step 60 of the method 48 is observing a respective band 30 that is not covered by a gum.

More specifically, and by way of example for a gingival pocket defined by a lower tooth and its associated gum, the color of the respective second recess 36 that is closest to the gum line is observed and its corresponding depth measurement (green: 2.0 mm, yellow: 4.0 mm, orange: 6.0 mm, or red: 8.0 mm) is noted. If a first recess 34 is visible between the respective second recess 36 and the gum line, then the measurement is lowered by 1.0 mm.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gingival pocket measurement device comprising:
a rod comprising:
a first segment extending from a first end of the rod, the first end being configured to be selectively attachable to an elongate shaft, such that the rod is removably mountable to the elongate shaft, and
a second segment extending from a second end of the rod to the first segment, the second segment tapering from a junction of the first segment and the second segment to the second end, such that the second end is circumferentially smaller than the junction; and
a plurality of bands attached to the second segment, each band extending circumferentially around the rod and having a respective color, such that the plurality of bands comprises bands having a variety of colors, the bands being positioned at 1.0 mm increments from the second end, wherein the rod is configured for insertion into a gingival pocket, enabling a user for measuring a depth of the gingival pocket by observing a respective band not covered by a gum.

2. The gingival pocket measurement device of claim 1, wherein the rod is integral to the elongate shaft.

3. The gingival pocket measurement device of claim 1, further including:
a bend positioned in the rod at the junction; and
a curve positioned in the rod substantially equally distant from the junction and the first end.

4. The gingival pocket measurement device of claim 1, wherein the plurality of bands comprises from seven to eleven bands.

5. The gingival pocket measurement device of claim 4, wherein the plurality of bands comprises nine bands.

6. The gingival pocket measurement device of claim 1, wherein the plurality of bands comprises:
a set on first recesses, the first recesses being black, a respective one of the first recesses being positioned at 1.0 mm from the second end of the rod; and
a set of second recesses, the second recesses being nonblack, each second recess being bracketed by two first recesses.

7. The gingival pocket measurement device of claim 6, wherein the set of second recesses comprises:
a second recess colored green and positioned at 2.0 mm from the second end;
a second recess colored yellow and positioned at 4.0 mm from the second end;
a second recess colored orange and positioned at 6.0 mm from the second end; and
a second recess colored red and positioned at 8.0 mm from the second end.

8. The gingival pocket measurement device of claim 1, further including:
a bend positioned in the rod at the junction;
a curve positioned in the rod substantially equally distant from the junction and the first end; and
the plurality of bands comprising nine bands, the plurality of bands comprising:
a set on first recesses, the first recesses being black, a respective one of the first recesses being positioned at 1.0 mm from the second end of the rod, and
a set of second recesses, each second recess being bracketed by two first recesses, the set of second recesses comprising:
a second recess colored green and positioned at 2.0 mm from the second end,
a second recess colored yellow and positioned at 4.0 mm from the second end,
a second recess colored orange and positioned at 6.0 mm from the second end, and
a second recess colored red and positioned at 8.0 mm from the second end.

9. The gingival pocket measurement device of claim 1, further including:
the rod comprising a first rod configured to be selectively attachable to a first endpoint of the elongate shaft;
the plurality of bands comprising a plurality of first bands;
a second rod, the second rod being a mirror image of the first rod and being configured to be selectively attachable to a second endpoint of the elongate shaft; and
a plurality of second bands attached to the second segment of the second rod, each second band extending circumferentially around the second rod and having a respective color, such that the plurality of second bands comprises second bands having a variety of colors, the second bands being positioned at 1.0 mm increments from the second end of the second rod, wherein the second rod is configured for insertion into the gingival pocket, enabling the user for measuring the depth of the gingival pocket by observing the respective second band not covered by the gum.

10. The gingival pocket measurement device of claim 9, wherein the first rod and the second rod are integral to the elongate shaft.

11. A method of measuring a depth of a gingival pocket comprising the steps of:
providing an elongate shaft;
providing a gingival pocket measurement device comprising:
a rod comprising:
a first segment extending from a first end of the rod, the first end being configured to be selectively attachable to an elongate shaft, such that the rod is removably mountable to the elongate shaft, and
a second segment extending from a second end of the rod to the first segment, the second segment tapering from a junction of the first segment and the second segment to the second end, such that the second end is circumferentially smaller than the junction, and
a plurality of bands attached to the second segment, each band extending circumferentially around the rod and having a respective color, such that the plurality of bands comprises bands having a variety of colors, the bands being positioned at 1.0 mm increments from the second end;
attaching the rod to the elongate shaft;
grasping the elongate shaft in a hand;
inserting the second segment of the rod into a gingival pocket; and
observing a respective band not covered by a gum.
